(19) United States
(12) Patent Application Publication
(10) Pub. No.: US 2004/0177013 A1
(43) Pub. Date: Sep. 9, 2004

(54) Periodical auditing system and method

(76) Inventor: Fenghua Zhou, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/788,516

(22) Filed: Feb. 27, 2004

(30) Foreign Application Priority Data
Feb. 27, 2003 (TW) 92104338

(51) Int. Cl. G06F 17/60

(52) U.S. Cl. 705/30; 705/37

(57) ABSTRACT

A periodical auditing system (1) includes an auditing periods definition module (10), a data collection module (11), a data transmission module (12), a return receipt identification module (13), a data carrying module (14) and a data inquiry module (15). A periodical auditing method includes the following steps: (a) defining auditing periods; (b) collecting demanded data on auditing, converting the demanded data on auditing into an electronic auditing file, and transmitting the electronic auditing file; (c) downloading a return receipt; (d) determining whether the declaration is acceptable; (e) determining whether information on book inventory matches information on physical inventory; and (f) carrying forward book inventory to a next auditing period.

### BACKGROUND OF THE INVENTION

1. Field of the Invention

The present invention relates generally to an auditing system and method, and more particularly to a periodical auditing system and method.

2. Background of the Invention

Commercial traders need to have a robust audit trail which can support the cross-referencing of supporting documentation for relevant declarations required by law. Such supporting documentation includes license and preference certificates, which need to be accounted for and submitted or discharged as required. In particular, traders need to agree on specific procedures with their local customs office for the presentation and retention of supporting documentation in accordance with the requirements of the relevant customs authority. Certain pre-clearance checks necessitate the presentation of supporting documentation at the customs frontier to enable enforcement of trade prohibitions and restrictions. Thus it is necessary to provide an efficacious auditing system for implementing the stringent auditing procedures.

However, at present, many customs authorities regards processing of a trading company's formalities as a kind of contract unit, in which each contract has a corresponding registered paper. The registered paper includes information on a name, specification and quantity of goods for transaction. A customs applicant must take the registered paper to handle customs clearance procedures for each transaction at the customs office. To apply for the registered paper, the customs applicant may need to register the transaction with a national industrial and commercial bureau, to open an account payable for the transaction in a specified bank, and to declare accordingly at customs. Oftentimes, the contract is changed or other contingencies arise. For example, the goods may be sold on domestic market instead. In these situations, it is necessary to inform the corresponding chief management department in turn so that re-auditing can be performed. That is, numerous contract changes and contingencies result in numerous applications for customs declaration.

The traditional auditing procedure includes the following steps. The customs applicant applies for the registered paper based on corresponding contracts, and fill in an application form for auditing. Typically, if there are in-process materials or end products that are to be carried forward, traders still need to provide an application form for carrying forward of records, invoices, contracts of carrying forward and shipping lists. The customs authority agrees on ending a case after it has audited the above supporting documentation. The trading company receives an announcement of ending of the case based on a registered card of a contract record.

Current declaration procedures are often largely manual. They can create a paper flow that becomes almost unmanageable. These current systems can causes undue delays in transactions, and many commercial problems for traders. Accordingly, it is desired to provide an automated periodical auditing system and method that can simplify customs auditing procedures and reduce the “paperwork mountain.”

### SUMMARY OF THE INVENTION

It is an objective of the present invention to provide a periodical auditing system and method which can collect demanded data on auditing and convert the demanded data on auditing into an electronic auditing file.

It is another objective of the present invention to provide a periodical auditing system and method for determining whether a customs declarations is acceptable and providing an explanation report on balancing of book inventory and physical inventory if the declaration is unacceptable.

To accomplish the above objectives, a periodical auditing system in accordance with a preferred embodiment of the present invention is provided. The periodical auditing system is connected with a plurality of client computers, an enterprise resource planning (ERP) system, an electronic data interchange (EDI) data transmission device, and a customs system. The client computers provide user interfaces for operators to create, update, inquire of and delete auditing periods. The ERP system is for receiving demanded data on auditing. The demanded data on auditing includes information on book inventory, information on physical inventory, information on quantities of in-process materials and information on units of in-process materials. The information on units of in-process materials refers to accounting units of in-process materials. The EDI data transmission device is used to store data on auditing. The data on auditing comprises declarations, electronic account books, return receipts and information on a customs bulletin board. The customs system obtains the data on auditing from the EDI data transmission device.

The periodical auditing system comprises an auditing periods definition module for defining auditing periods, and for creating, updating, inquiring of and deleting the auditing periods; a data collection module for collecting the demanded data on auditing; a data transmission module for converting the demanded data on auditing into an electronic auditing file according to a format of EDI reporting required by a relevant customs authority, and for transmitting the electronic auditing file to the EDI data transmission device for use; a return receipt identification module for downloading a return receipt, for determining whether a declaration is acceptable, and for determining whether the information on book inventory matches the information on physical inventory; a data carrying module for updating book inventory, and for carrying forward the updated book inventory to a next auditing period; and a data inquiry module for inquiring of the data on auditing.

The present invention also provides a periodical auditing method. The periodical auditing method comprises the following steps: (a) defining auditing periods; (b) collecting demanded data on auditing; (c) converting the demanded data on auditing into an electronic auditing file according to a format of EDI reporting required by a relevant customs authority, and transmitting the electronic auditing file; (d) downloading a return receipt; (e) determining whether a declaration is acceptable; (f) determining whether information on book inventory matches information on physical inventory; and (g) carrying forward book inventory to a next auditing period.

Further objects of the present invention, together with additional features and advantages, will be apparent from the following description of the preferred embodiment of the present invention which is shown in and which is to be read in conjunction with the accompanying drawings, wherein:

### BRIEF DECRIPTION OF THE DRAWINGS

FIG. 1 is a schematic diagram of an application environment of a periodical auditing system in accordance with a preferred embodiment of the present invention;

FIG. 2 is a block diagram of software infrastructure of the periodical auditing system shown in FIG. 1;

FIG. 3 is a flowchart showing the steps for implementing the periodical auditing system of the present invention; and

FIG. 4 is a schematic diagram showing a data flow of the periodical auditing process.

### DETAILED DESCRIPTION OF THE INVENTION

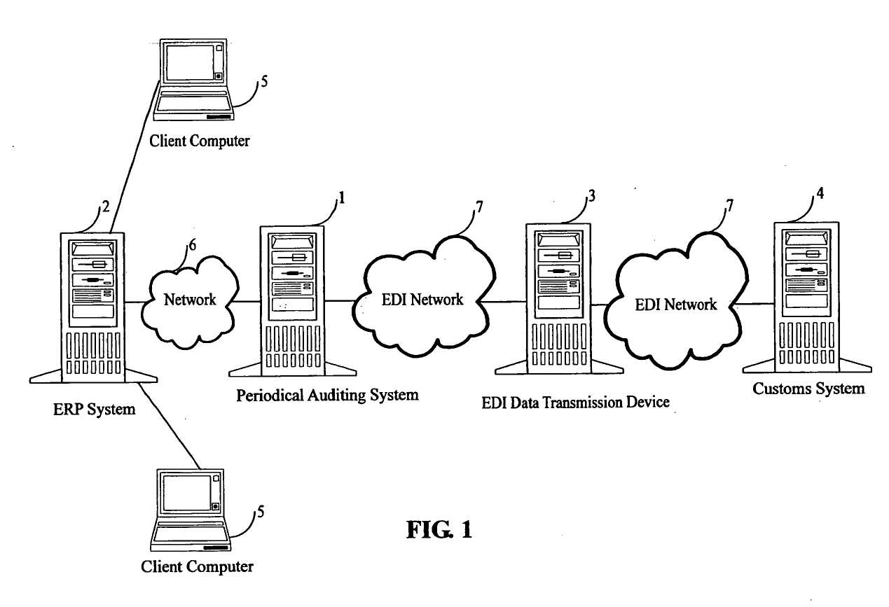

FIG. 1 is a schematic diagram of hardware configuration of a periodical auditing system 1 in accordance with a preferred embodiment of the present invention. The periodical auditing system 1 collects and processes demanded data on auditing which is transmitted from an enterprise resource planning (ERP) system 2 according to requirements of an enterprise. After that, the periodical auditing system 1 transmits the demanded data on auditing to an electronic data interchange (EDI) data transmission device 3. The demanded data on auditing includes information on inventory, information on quantities of in-process materials and information on units of in-process materials. The information on units of in-process materials refers to accounting units of in-process materials. The information on inventory includes information on book inventory and information on physical inventory. The periodical auditing system 1 is connected with the ERP system 2 via a network 6. The network 6 may be an Intranet, the Internet or another similar electronic communications networks. The ERP system 2 is for receiving the demanded data on auditing. The ERP system 2 is connected with a plurality of client computers 5, which provide user interfaces for operators to create, update, inquire of and delete auditing periods. Each of the client computers 5 is located in different places of a customs organization, and is configured to operate in a Microsoft Windows 95, Windows 98 or Windows NT environment.

The periodical auditing system 1 is connected with the EDI data transmission device 3 via an electronic data interchange (EDI) network 7. The EDI network 7 is an EDI data transmission network provided with a customs interface of standard specification. The EDI data transmission device 3 is connected with a customs system 4 via the EDI network 7, and is used to store data on auditing. The data on auditing comprises declarations, electronic account books, return receipts, and information on a customs bulletin board. The declarations include import declarations and export declarations. If the information on a declaration matches the corresponding information on book inventory, the declaration is acceptable. Otherwise, the declaration is unacceptable. The customs system 4 obtains the data on auditing from the EDI data transmission device 3 via the EDI network 7.

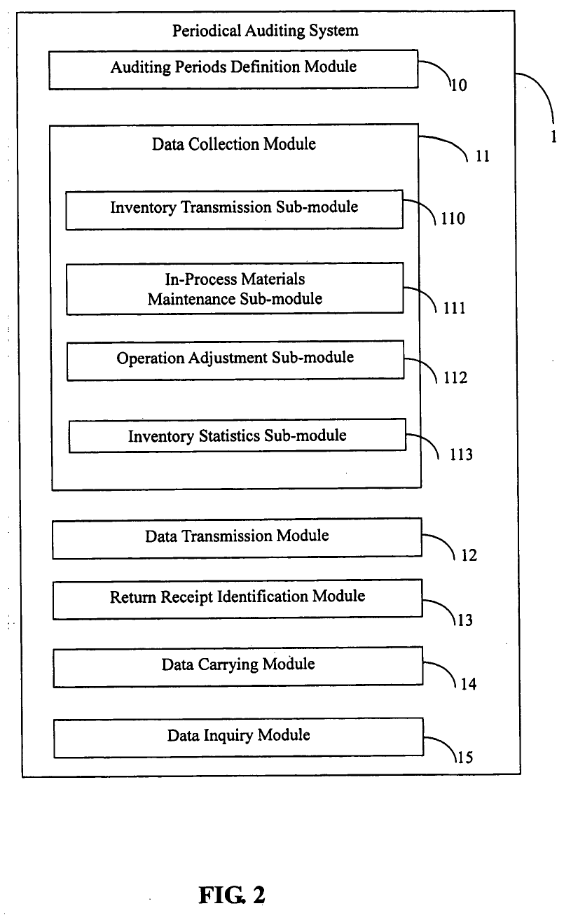

FIG. 2 is a block diagram showing main function modules of the periodical auditing system 1. The periodical auditing system 1 comprises an auditing periods definition module 10, a data collection module 11, a data transmission module 12, a return receipt identification module 13, a data carrying module 14, and a data inquiry module 15. The auditing periods definition module 10 is used for defining the auditing periods, and for creating, updating, inquiring of and deleting the auditing periods.

The data collection module 11 collects the demanded data on auditing. The data collection module 11 comprises an inventory transmission sub-module 110, an in-process materials maintenance sub-module 111, an operation adjustment sub-module 112, and an inventory statistics sub-module 113.

The inventory transmission sub-module 110 converts the information on inventory from the ERP system 2 into an Excel compatible file, and transmits the Excel compatible file to the periodical auditing system 1 at the end of each auditing period. The in-process materials maintenance sub-module 111 transmits the information on quantities of in-process materials and information on units of in-process materials as at a cut-off time from the ERP system 2 to the periodical auditing system 1 at the end of each auditing period. The operation adjustment sub-module 112 records information on inventory change. This is the result of balancing of book inventory and physical inventory as at the cut-off times at the end of each auditing period. The inventory statistics sub-module 113 counts the quantity of physical inventory and book inventory at the end of each auditing period.

The data transmission module 12 converts the demanded data on auditing to an electronic auditing file according to the format of EDI reporting required by the relevant customs authority, and transmits the electronic auditing file to the EDI data transmission device 3 for use. The electronic auditing file includes the electronic account books, the data on auditing, the declarations and the return receipts.

The return receipt identification module 13 downloads the return receipts from the customs system 4 via the EDI network 7, and determines whether the declarations are acceptable based on the return receipts. If the information on a declaration matches the corresponding information on book inventory, the declaration is acceptable. Otherwise, the declaration is unacceptable. If the declaration is unacceptable, the data collection module 11 collects, and processes the demanded data on auditing and transmits the demanded data on auditing again. If the declaration is acceptable, the return receipt identification module 13 determines whether the information on physical inventory matches the information on book inventory. The periodical auditing system 1 provides an explanation report on balancing of physical inventory and book inventory to the customs system 4, and collects corresponding tax if the information on book inventory does not match the information on physical inventory.

The data carrying module 14 updates the book inventory if the information on book inventory matches the information on physical inventory. Further, the data carrying module 14 carries forward the updated book inventory to the next auditing period. The data inquiry module 15 is for inquiring of the data on auditing.

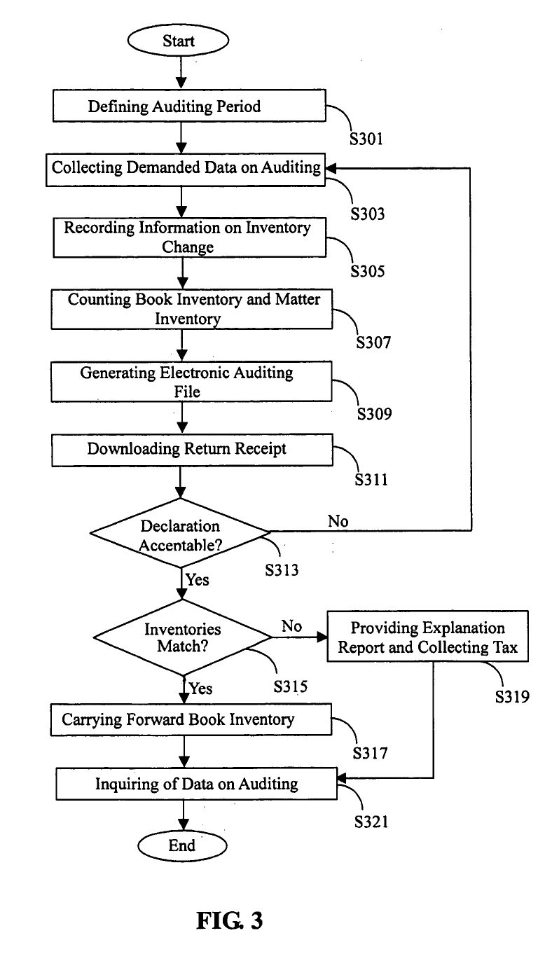

FIG. 3 is a flowchart of preferred steps of a periodical auditing method of the present invention. In step S301, the auditing periods definition module 10 defines a plurality of auditing periods. The auditing periods definition module 10 sets serial numbers of electronic account books, account years, starting times, cut-off times, names and states of the auditing periods and validity labels, and stores the set information in the periodical auditing system 1. The state of an auditing period can be past, current, or future. Moreover, the auditing periods definition module 10 can create, update, inquire of and delete the auditing periods.

In step S303, the inventory transmission sub-module 110 of the data collection module 11 converts the information on inventory into an Excel compatible file, and transmits the Excel compatible file to the periodical auditing system 1 at the end of the auditing period. The in-process materials maintenance sub-module 111 of the data collection module 11 collects the information on quantities of in-process materials and information on units of in-process materials as at the cut-off time, and transmits the collected information to the periodical auditing system 1 at the end of the auditing period.

In step S305, the operation adjustment sub-module 112 of the data collection module 11 records information on inventory change based on balancing of physical inventory and book inventory as at the cut-off time at the end of the relevant auditing periods. In step S307, the inventory statistics sub-module 113 of the data collection module 11 counts the quantity of book inventory and physical inventory at the end of the auditing period. In step S309, the data transmission module 12 converts the demanded data on auditing into an electronic auditing file according to the format of EDI reporting required by the relevant customs authority, and transmits the electronic auditing file to an EDI data transmission device 3 for use. The customs system 4 downloads the electronic auditing file from the EDI data transmission device 3 via an EDI network 7.

In step S311, the return receipt identification module 13 downloads the return receipt from the EDI data transmission device 3. In step S313, the return receipt identification module 13 determines whether the declaration is acceptable according to the return receipt. If the declaration is unacceptable, the data collection module 11 collects the demanded data on auditing for auditing again. If the declaration is acceptable, in step S315, the return receipt identification module 13 determines whether the information on book inventory matches the information on physical inventory. If the information on book inventory matches the information on physical inventory, in step S317, the inventory statistic sub-module 113 of the data collection module 11 counts the quantity of book inventory. The data carrying module 14 updates the book inventory, and carries forward the updated book inventory to the next audit period. Otherwise, in step S319, the periodical auditing system 1 provides an explanation report on the balancing of physical inventory and book inventory to the EDI data transmission device 3, and collects corresponding tax. In step S321, the enterprises may inquire of the data on auditing according to needs. The serial number of the electronic account book, account year, starting time, cut-off time, or name and state of auditing period can be selected for inquiry.

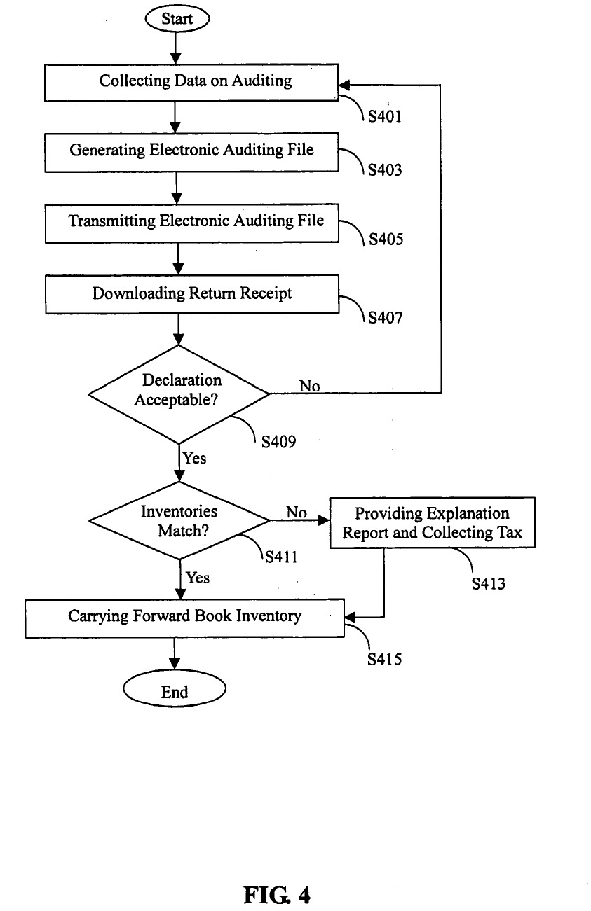

FIG. 4 is a diagram showing data flow of the above-described periodical auditing process. In step S401, the data collection module 11 collects the demanded data on auditing from the ERP system 2. In step S403, the data transmission module 12 converts the demanded data on auditing into an electronic auditing file according to the format of EDI reporting required by the relevant customs authority. In step S405, the data transmission module 12 transmits the electronic auditing file to the customs system 4. In step S407, the return receipt identification module 13 downloads the corresponding return receipt from the EDI data transmission device 3. In step S409, the return receipt identification module 13 determines whether the declaration is acceptable. If the declaration is unacceptable, the data collection module 11 collects the demanded data on auditing again. If the declaration is acceptable, in step S411, the return receipt identification module 13 determines whether the information on physical inventory matches the corresponding information on book inventory. If the information on physical inventory matches information on book inventory, in step S415, the inventory statistics sub-module 113 of the data collection module 11 counts the quantity of the book inventory. The data carrying module 14 updates the book inventory and carries forward the updated book inventory to the next auditing period. Otherwise, in step S413, the periodical auditing system 1 provides an explanation report on the balancing of the physical inventory and book inventory, and collects corresponding tax.

While the invention is susceptible to various modifications and alternative forms, specific embodiments thereof have been shown by way of example in the drawings and have been described in detail. It should be understood, however, that is not intended to limit the invention to the particular forms disclosed. On the contrary, the intention is to cover all modifications, equivalents, and alternatives falling within the spirit and scope of the invention as defined by the appended claims.

What is claimed is:

1. A periodical auditing system connected with an enterprise resource planning (ERP) system, an electronic data interchange (EDI) data transmission device, a customs system and a plurality of client computers, the periodical auditing system comprising:
an auditing periods definition module for defining auditing periods, and for creating, updating, inquiring of and deleting the auditing periods;
a data collection module for collecting demanded data on auditing, wherein the demanded data on auditing includes information on physical inventory, information on book inventory, information on quantities of in-process materials and information on units of in-process materials, the information on units of in-process materials being accounting units of in-process materials;
a data transmission module for converting the demanded data on auditing into an electronic auditing file according to a format of EDI reporting required by a relevant customs authority, and for transmitting the electronic auditing file to the customs system;
a return receipt identification module for downloading a return receipt from the customs system, for determining whether a declaration is acceptable, for determining whether information on book inventory matches information on physical inventory, and for providing an explanation report on balancing of book inventory and physical inventory;
a data carrying module for updating book inventory, and for carrying forward the updated book inventory to a next auditing period; and
a data inquiry module for inquiring of data on auditing, the data on auditing including declarations, electronic account books, return receipts and information on a customs bulletin board.

2. The periodical auditing system according to claim 1, wherein the auditing periods definition module sets serial numbers of electronic account books, account years, cut-off times, starting times, names and states of the auditing periods.

3. The periodical auditing system according to claim 1, wherein the electronic auditing file includes an electronic account book, data on auditing, the declaration and the return receipt.

4. The periodical auditing system according to claim 1, wherein the data collection module comprises an inventory transmission sub-module for converting the information on book inventory and information on physical inventory into an Excel compatible file, and for transmitting the Excel compatible file at the end of each auditing period.

5. The periodical auditing system according to claim 1, wherein the data collection module comprises an in-process materials maintenance sub-module for transmitting the information on quantities of in-process materials and information on units of in-process materials.

6. The periodical auditing system according to claim 1, wherein the data collection module comprises an inventory statistics sub-module for counting the quantity of the book inventory and physical inventory.

7. The periodical auditing system according to claim 1, wherein the data collection module comprises an operation adjustment sub-module for recording information on inventory change based on balancing of the book inventory and physical inventory.

8. A periodical auditing method comprising the steps of;
defining auditing periods;
collecting demanded data on auditing, the demanded data on auditing including information on book inventory, information on physical inventory, information on quantities of in-process materials and information on units of in-process materials, the information on units of in-process materials being accounting units of in-process materials;
converting the demanded data on auditing into an electronic auditing file according to a format of EDI reporting required by a relevant customs authority and transmitting the electronic auditing file;
downloading a return receipt;
determining whether a declaration is acceptable;
determining whether the information on book inventory matches the information on physical inventory;
providing an explanation report on balancing of physical inventory and book inventory if the information on book inventory does not matches the information on physical inventory; and
carrying forward book inventory to a next auditing period.

9. The periodical auditing method according to claim 8, wherein the step of collecting the demanded data on auditing comprises the step of converting the information on book inventory and information on physical inventory into an Excel compatible file, and transmitting the Excel compatible file at the end of each auditing period.

10. The periodical auditing method according to claim 8, wherein the step of collecting the demanded data on auditing comprises the step of collecting the information on quantities of in-process materials and information on units of in-process materials as at a cut-off time, and transmitting the collected information.

11. The periodical auditing method according to claim 8, wherein the step of collecting the demanded data on auditing comprises the step of recording information on inventory change based on balancing of book inventory and physical inventory as at a cut-off time at the end of each auditing period.

12. The periodical auditing method according to claim 8, wherein the step of collecting the demanded data on auditing comprises the step of counting a quantity of book inventory and physical inventory as at a cut-off time at the end of each auditing period.

13. The periodical auditing method according to claim 8, wherein the step of determining whether the declaration is acceptable comprises the step of collecting the demanded data on auditing again if the declaration is unacceptable.

14. The periodical auditing method according to claim 8, wherein the step of carrying forward the book inventory comprises the step of counting a quantity of the book inventory and updating the book inventory.

15. The periodical auditing method according to claim 8, further comprising the step of inquiring of information on any or more of declarations, electronic account books, return receipts and information on a customs bulletin board.

16. A periodical auditing method comprising the steps of;
defining auditing periods;
collecting demanded data on auditing, the demanded data on auditing including information on book inventory and information on physical inventory;
converting the demanded data on auditing into an electronic auditing file according to a format of EDI reporting required by a relevant customs authority and transmitting the electronic auditing file;
downloading a return receipt;
determining whether the information on book inventory matches the information on physical inventory;
providing an explanation report on balancing of physical inventory and book inventory if the information on book inventory does not matches the information on physical inventory; and
carrying forward book inventory to a next auditing period.
